(19) United States
(12) Patent Application Publication
(10) Pub. No.: US 2022/0194068 A1
(43) Pub. Date: Jun. 23, 2022

(54) LAMINATE FLOOR AND MANUFACTURING PROCESS THEREOF

(71) Applicant: Jiangsu Langyue New Materials Technology Co., Ltd., Zhenjiang City (CN)

(72) Inventor: Guoping LI, Zhenjiang City (CN)

(21) Appl. No.: 17/692,808

(22) Filed: Mar. 11, 2022

Related U.S. Application Data
(63) Continuation of application No. PCT/CN2020/114789, filed on Sep. 11, 2020.

(30) Foreign Application Priority Data
Sep. 12, 2019 (CN) 201910864422.6

(51) Int. Cl. B32B 29/02; B32B 37/06; B32B 37/10; B32B 37/08; B32B 7/12; B32B 21/14; B32B 5/18; B32B 21/06; B32B 27/12; B32B 29/00; B32B 29/06; C09J 7/29; C09J 7/35; E04F 15/10

(52) U.S. Cl. CPC B32B 29/02; C09J 2477/00; B32B 37/10; B32B 37/08; B32B 7/12; B32B 21/14; B32B 5/18; B32B 21/06; B32B 27/12; B32B 29/007; B32B 29/06; C09J 7/29; C09J 7/35; E04F 15/107; B32B 2266/0221; B32B 2266/025; B32B 2307/554; B32B 2471/00; C09J 2203/346; C09J 2301/16; C09J 2400/263; C09J 2400/123; C09J 2400/303; C09J 2400/243; C09J 2427/006; C09J 2479/026; C09J 2431/006; C09J 2423/046; C09J 2415/00; B32B 37/06

(57) ABSTRACT

Disclosed is a composite floor, comprising a wear-resistant layer, a polyvinyl chloride patterned fabric layer, a base material layer, a balance layer, and a muting layer that are sequentially arranged, the wear-resistant layer being a melamine wear-resistant paper layer. The composite floor has a clear and vivid pattern, and the wear and scratch resistance is far better than that of a conventional floor, the manufacturing process comprising laying, hot pressing, demolding and tempering steps. The manufacturing process has simple steps, and the obtained composite floor has high dimensional stability and good wear and scratch resistance.

### CROSS-REFERENCE TO RELATED APPLICATION

This application is a continuation of PCT application serial no. PCT/CN2020/114789, filed on Sep. 11, 2020, which claims the priority and benefit of Chinese patent application serial no. 201910864422.6, filed on Sep. 12, 2019. The entirety of PCT application serial no. PCT/CN2020/114789 and Chinese patent application serial no. 201910864422.6 are hereby incorporated by reference herein and made a part of this specification.

### TECHNICAL FIELD

The present application relates to a laminate floor and manufacturing process thereof.

### BACKGROUND ART

A laminate floor is widely popular because of its decoration property and much better wear resistance and dimensional stability than traditional bamboo wood flooring. For example, the Chinese patent application publication number CN104847082B discloses a flame-retardant polyvinyl chloride (PVC) floor, which includes a base layer, a decorative layer on the base layer and a wear-resistant layer on the decorative layer. The materials of the base layer include polyvinyl chloride powder, flame retardant and coupling agent, the decorative layers are decorative paper treated by melamine, the materials of the wear-resistant layer includes polyvinyl chloride powder and flame retardant. Further, the material of at least one of the base layers and wear-resistant layers includes a smoke suppressant. Melamine impregnated paper is selected as the decorative layer.

However, polyvinyl chloride wear-resistant layer only has a wear resistance of medium level, therefore, the floor tends to be roughened due to long-time trampling, rubbing and scratching during use, which will directly affect the decorative effect of the decorative layer, and render the patterns or lines of the decorative layer blurred and the sharpness degraded.

### SUMMARY

In view of the shortcomings of the prior art, the present application provides a laminate flooring, which has the advantages of good wear resistance and sharp decorative layer pattern for a long time.

In one aspect, the present application provides the following technical solution:

a laminate flooring includes laminated wear-resistant layer, polyvinyl chloride patterned fabric layer, substrate layer, balance layer and mute layer, in which the wear-resistant layer is melamine wear-resistant paper layer.

In the above technical solution, it has at least the following beneficial effects:

In the laminate floor in the present application, the melamine wear-resistant paper layer with better wear resistance is selected to replace a polyvinyl chloride wear-resistant layer, so that the wear-resistant of the floor can be greatly improved. Meanwhile, the polyvinyl chloride patterned fabric layer is adopted in replace of a conventional melamine impregnated paper decorative layer, so that the decorative patterns or patterns are sharp and vivid. The laminate floor of the present applicant has simple structure but excellent wear resistance, so that it can maintain the sharpness of decorative patterns for a long time. The providing of the balance layer renders the overall size of the laminate floor stable and not easy to deform or warp. The mute layer can improve the sound insulation and noise reduction effect of the floor.

Further, the front face and/or back face of the polyvinyl chloride patterned fabric layer is provided with an adhesive layer.

In the above technical solution, the compounding firmness between the polyvinyl chloride patterned fabric layer and the adjacent material layers can be improved, so that the overall dimensional stability of the laminate floor can be improved.

Further, the adhesive layer includes the following components by weight,

chlorinated rubber 2-7 parts;

perchloroethylene resin 8-12 parts;

modified low-molecular polyamide hot-melt adhesive 2-7 parts;

tall oil 2-7 parts;

antioxidant 0.5-1.5 parts; and

organic solvent 60-90 parts.

The adhesive layer with the above ratio has high adhesion and excellent waterproof performance, so that there is no ungluing, cracking and swelling between the polyvinyl chloride patterned fabric layer and the adjacent material layers, so that the dimensional stability and wear resistance of the laminate floor can be improved.

The low-molecular polyamide hot-melt adhesive is prepared by condensing dimer or trimer of an aliphatic acid and an organic amine, and then grafting and crosslinking it with the aliphatic dibasic acid (HOOC-R-COOH, in which R represents alkyl) at the presence of crosslinking agent. Preferably, R is C₂-C₁₂ alkyl dicarboxylic acid-modified low-molecular polyamide hot-melt adhesive, which can greatly improve the toughness of the prepared modified low-molecular polyamide hot-melt adhesive. The modified low-molecular polyamide hot-melt adhesive of the present applicant can be a self-made modified hot-melt adhesive or a commercially available modified hot-melt adhesive.

The antioxidants suitable for hot-melt adhesive sold are commercially available, such as antioxidant 1726 [2,4-bis (dodecyl thiomethyl)-6-methylphenol], antioxidant 801, antioxidant 808, etc. The organic solvent can be one or more selected from a group consisting of ethyl acetate, butyl acetate, butanone, acetone and other organic solvents.

Further, the substrate layer is selected from a group consisting of stone-plastic composite substrate layer and wood-plastic composite substrate layer.

The stone-plastic composite substrate layer has advantages of light weight, environmental friendliness, wear resistance and fire resistance. The wood-plastic composite substrate layer has advantages of environmental friendliness, excellent mechanical properties and good dimensional stability. The two materials render the implementation of the technical solution of the present applicant easier.

Further, the mute layer is cork layer, ethylene-vinyl acetate copolymer foam (EVA foam) or irradiation crosslinked polyethylene foam (IXPE foam).

By adopting the above technical solution, the effect of sound absorption and noise reduction of the laminate floor can be achieved.

Further, the polyvinyl chloride patterned fabric layer includes pattern layer printed by water-based polyvinyl chloride ink or oily polyvinyl chloride ink.

In the above technical solution, the decorative pattern of laminate floor has the advantages of high sharpness and vividness, so that the decorative effect is better than melamine impregnated decorative paper.

Further, the balance layer is selected from a group consisting of a balance paper layer, a melamine wear-resistant paper layer, or a combination of a polyvinyl chloride film and a melamine balance paper layer.

In the above technical solution, the balance layer can balance the deformation difference between surface layer and bottom layer of the laminate floor, so that the stability of dimension and the moisture proof and corrosion resistance can be improved.

Further, in another aspect, the present application provides manufacturing process of a laminate floor. The laminate floor made by the manufacturing process has the advantages of excellent moisture and corrosion resistance, high dimensional stability and excellent durability.

In some embodiments, the present applicant provides the following technical solution:

a manufacturing process of a laminate floor includes the following steps: material laying: laying the mute layer, the balance layer, the substrate layer, the polyvinyl chloride patterned fabric layer, and the wear-resistant layer from bottom to top in a mold of a laminating equipment, in which the wear-resistant layer is a melamine wear resistant paper layer.

heat pressing: performing heat pressing at 130-150° C. and 5-21 MPa for 20-60 min;

demoulding: air cooling to room temperature and demoulding to obtain the laminate floor; and

tempering: performing a second heat pressing at 80-100° C. to the laminate floor after demoulding.

The above technical solution involves in a simple manufacturing process, including material laying and then performing one heat pressing. The subsequent tempering process can improve the dimension stability of the laminate floor and greatly improve the use performance of the laminate floor. The laminate floor made by the manufacturing process of the present applicant has the advantages of high dimensional stability and excellent wear resistance.

Further, the tempering process is carried out after completely cooling the laminate floor obtained by demoulding and curing for 24 hours.

In the above technical solution, the dimensional stability of the laminate floor can be improved significantly.

In summary, the present applicant has the following effects.

1. The laminate floor of the present applicant adopts a combination of melamine wear-resistant paper layer and polyvinyl chloride patterned fabric layer, which can not only provide a sharper and vivider decorative pattern than conventional melamine decorative papers, but also can greatly improve the wear resistance and scratch resistance comparing to a floor provided with a polyvinyl chloride wear-resistant layer;

2. the front face and/or back face of the polyvinyl chloride patterned fabric layer is provided with an adhesive layer with a specific component ratio, so that the compounding firmness of the laminate floor can be significantly improved, and the wear resistant of the laminate floor can be improved;

3. providing the balance layer and the mute layer can provide the laminate floor with the effects of high dimensional stability, excellent sound absorption and noise reduction; and

4. the manufacturing process of the laminate floor provided by the present applicant involves in simple process steps, and can obtain a laminate floor with excellent dimensional stability and wear resistant.

### BRIEF DESCRIPTION OF THE DRAWINGS

FIG. 1 is a structural diagram of a laminate floor according to an embodiment.

FIG. 2 is a structural diagram of the polyvinyl chloride patterned fabric layer and the adhesive layer according to an embodiment.

FIG. 3 is a process flow chart of a manufacturing process of the laminate floor according to an embodiment.

In the figures: 1. Wear-resistant layer; 2. Polyvinyl chloride patterned fabric layer; 21. Adhesive layer; 22. Pattern layer; 23. Base layer; 3. Substrate layer; 4. Balance layer; 5. Mute layer.

### DETAILED DESCRIPTION

The present application is further described in detail below in combination with the accompanying drawings.

### Example 1

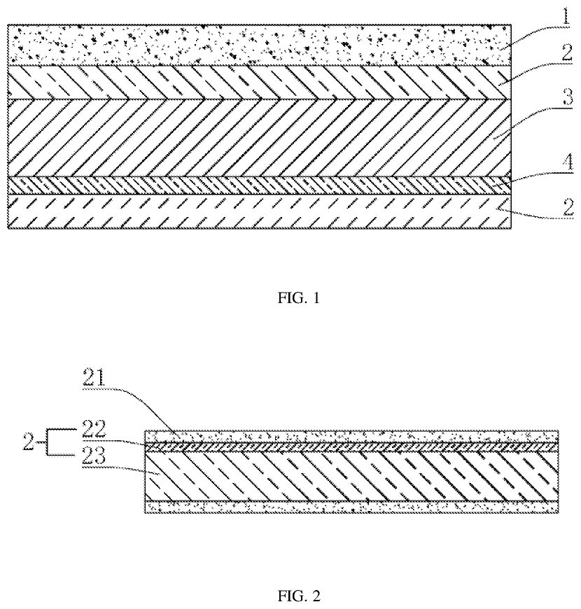

Referring to FIG. 1, a laminate floor included a wear-resistant layer 1, a polyvinyl chloride patterned fabric layer 2, a substrate layer 3, a balance layer 4 and a mute layer 5, which were arranged in turn. The wear-resistant layer 1 was a melamine wear-resistant paper layer, and the substrate layer 3 was a stone-plastic composite substrate layer. The balance layer 4 was formed by heat pressing a composite balance paper (200 g/m², obtained from Zhejiang Xiawang Paper Co., Ltd.) on the substrate layer 3, and the mute layer 5 was cork layer.

Referring to FIG. 2, the polyvinyl chloride patterned fabric layer 2 included a base layer 23 and a pattern layer 22 formed by printing a water-based polyvinyl chloride ink on the front face of the body layer 23. The front face and back face of the polyvinyl chloride patterned fabric layer 2 were provided with an adhesive layer 21. The adhesive layer 21 was formed by coating a glue prepared from the following raw materials:

chlorinated rubber 5 g;

perchloroethylene resin 10 g;

modified low-molecular polyamide hot-melt adhesive 5 g;

tall oil 5 g;

antioxidant 1726 1 g;

butyl acetate 50 g; and

butanone 24 g,

where the modified low-molecular polyamide hot-melt adhesive was butanedioic acid-modified low-molecular polyamide hot-melt adhesive, having an average molecular weight of 3000 g/mol, and the tall oil was obtained from SIMAGCHEM CORP, having a saponification value of 156.

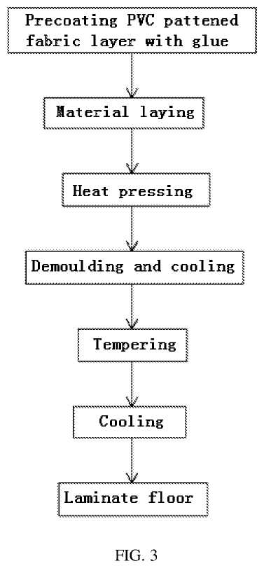

Referring to FIG. 3, the manufacturing process of the laminate floor of the present example was as follows:

the raw materials were weighed according to the above formula, heated to melt, and mixed evenly to obtain a pretreated glue. Then, the pretreated glue was evenly coated on the surface of the polyvinyl chloride patterned fabric layer 2 to form the adhesive layer 21.

Then, the cork layer, the balance paper, the stone-plastic composite substrate layer, the polyvinyl chloride patterned fabric layer 2, and the melamine wear-resistant paper layer were laid in a mold of a laminating equipment from bottom to top. Then the heat pressing was carried out at 140° C. and 15 MPa, in which the heat pressing time was 30 min.

After heat pressing, the laminate was air cooled to room temperature and demoulded to obtain the laminate floor. The obtained laminate floor was cured at room temperature for 24 h, and then tempered. Tempering was conducted on a multi-layer hot pressing equipment, with tempering temperature of 90° C. and tempering time of 15 min. After tempering, the finished was removed at a temperature of ≤80° C., and then air cooled to room temperature to obtain the finished laminate floor.

### Example 2

Referring to FIG. 1, a laminate floor, included a wear-resistant layer 1, a polyvinyl chloride patterned fabric layer 2, a substrate layer 3, a balance layer 4 and a mute layer 5, which were arranged in turn. The wear-resistant layer 1 was melamine wear-resistant paper layer, and the substrate layer 3 was stone-plastic composite substrate layer. The balance layer 4 was melamine wear-resistant paper layer, and the mute layer 5 was ethylene vinyl acetate copolymer foam layer.

Referring to FIG. 2, the polyvinyl chloride patterned fabric layer 2 included a base layer 23 and pattern layer 22 formed by printing a water-based polyvinyl chloride ink on the front face of the body layer 23. The front face and back face of the polyvinyl chloride patterned fabric layer 2 were provided with an adhesive layer 21. The adhesive layer 21 was formed by coating a glue formulated from the following materials:

chlorinated rubber 2 g;

perchloroethylene resin 8 g;

modified low-molecular polyamide hot-melt adhesive 2 g;

tall oil 2 g;

antioxidant 1726 0.5 g;

butyl acetate 40 g; and

butanone 20 g.

where the modified low-molecular polyamide hot-melt adhesive was butanedioic acid modified low-molecular polyamide hot-melt adhesive, having an average molecular weight of 3000 g/mol, and the tall oil was obtained from SIMAGCHEM CORP, having a saponification value of 156.

Referring to FIG. 3, the manufacturing process of the laminate floor of the present example was as follows:

the raw materials were weighed according to the above formula, heated to melt and mixed evenly to obtain a pretreated glue. Then, the pretreated glue was evenly coated on the surface of the polyvinyl chloride patterned fabric layer 2 to form the adhesive layer 21.

Then, the ethylene vinyl acetate copolymer foam layer, the balance paper, the stone-plastic composite substrate layer, the polyvinyl chloride patterned fabric layer 2, and the melamine wear-resistant paper layer were laid in the mold of the laminating equipment from bottom to top. Then the heat pressing was carried out at 130° C. and 21 MPa, in which the heat pressing time was 30 min.

After heat pressing, the laminate was air cooled to room temperature and demoulded to obtain the laminate floor. The laminate floor obtained was cured at room temperature for 24 h, and then tempered. The tempering was conducted on the multi-layer hot pressing equipment, with tempering temperature of 80° C. and tempering time of 20 min. After tempering, the finished laminate floor was removed at a temperature of ≤80° C., and then was air cooled to room temperature.

### Example 3

Referring to FIG. 1, a laminate floor included a wear-resistant layer 1, a polyvinyl chloride patterned fabric layer 2, a substrate layer 3, a balance layer 4 and a mute layer 5, which were arranged in turn. The wear-resistant layer 1 was melamine wear-resistant paper layer, and the substrate layer 3 was wood-plastic composite substrate layer. The balance layer 4 was compounded from polyvinyl chloride film and balance paper (200 g/m², obtained from Zhejiang Xiawang Paper Co., Ltd.), and the polyvinyl chloride film was compounded on the substrate layer 3, and the mute layer 5 was an irradiation crosslinked polyethylene foam.

Referring to FIG. 2, the polyvinyl chloride patterned fabric layer 2 included a base layer 23 and pattern layer 22 formed by printing a water-based polyvinyl chloride ink on the front face of the body layer 23. The front face and back face of the polyvinyl chloride patterned fabric layer 2 were provided with an adhesive layer 21. The adhesive layer 21 was formed by coating glue formulated from the following materials:

chlorinated rubber 3 g;

perchloroethylene resin 10 g;

modified low-molecular polyamide hot-melt adhesive 3 g;

tall oil 3 g;

antioxidant 801 lg;

butyl acetate 50 g; and

butanone 30 g;

where the modified low-molecular polyamide hot-melt adhesive was butanedioic acid modified low-molecular polyamide hot-melt adhesive, having an average molecular weight of 3000 g/mol, and the tall oil was obtained from SIMAGCHEM CORP, having a saponification value of 156.

Referring to FIG. 3, the manufacturing process of the laminate floor of the present example was as follows:

the raw materials were weighed according to the above formula, heated to melt, and mixed evenly to obtain the pretreated glue. Then, the pretreated glue was evenly coated on the surface of the polyvinyl chloride patterned fabric layer 2 to form the adhesive layer 21.

Then, the irradiation crosslinked polyethylene foam, the balance layer 4 compounded from polyvinyl chloride film and balance paper, wood-plastic composite substrate layer, polyvinyl chloride patterned fabric layer 2, and melamine wear-resistant paper layer were laid in the mold of the laminating equipment from bottom to top. Then the heat pressing was carried out at 140° C. and 10 MPa, in which the heat pressing time was 40 min.

After heat pressing, the laminate was air cooled to room temperature and demoulded to obtain the laminate floor. The laminate floor obtained was cured at room temperature for 24 h, and then tempered. The tempering was conducted on the multi-layer hot pressing equipment, with tempering temperature of 100° C. and tempering time of 10 min. After tempering, the finished laminate floor was removed at a temperature of ≤80° C., and then was air cooled to room temperature.

### Example 4

A laminate floor, referring to FIG. 1, included a wear-resistant layer 1, a polyvinyl chloride patterned fabric layer 2, a substrate layer 3, a balance layer 4 and a mute layer 5, which were arranged in turn. The wear-resistant layer 1 was melamine wear-resistant paper layer, and the substrate layer 3 was stone-plastic composite substrate layer. The balance layer 4 was melamine wear-resistant paper layer, and the mute layer 5 was ethylene vinyl acetate copolymer foam layer.

Referring to FIG. 2, the polyvinyl chloride patterned fabric layer 2 included a base layer 23 and pattern layer 22 formed by a water-based polyvinyl chloride ink printing on the front face of the body layer 23. The front face and back face of the polyvinyl chloride patterned fabric layer 2 was provided with an adhesive layer 21. The adhesive layer 21 was formed by coating a glue formulated from the following materials:

chlorinated rubber 7 g;

perchloroethylene resin 12 g;

modified low-molecular polyamide hot-melt adhesive 7 g;

tall oil 7 g;

antioxidant 801 1.0 g;

antioxidant 808 0.5 g;

butyl acetate 60 g; and

butanone 30 g;

where the modified low-molecular polyamide hot-melt adhesive was butanedioic acid modified low-molecular polyamide hot-melt adhesive, the average molecular weight was 3000 g/mol, the saponification value of tall oil was 156, which was obtained from SIMAGCHEM CORP. The antioxidant 801 had a purity of 99%, obtained from Weihai Huaen rubber and plastic new material Co., Ltd. Antioxidant 808 was of industrial grade, obtained from Kunshan yayang Composite Technology Co., Ltd.

Referring to FIG. 3, the manufacturing process of the laminate floor of the present example was as follows:

the raw materials were weighed according to the above formula, heated to melt, and mixed evenly to obtain the pretreated glue. Then, the pretreated glue was evenly coated on the surface of the polyvinyl chloride patterned fabric layer 2 to form the adhesive layer 21.

Then, the ethylene vinyl acetate copolymer foam layer, the melamine wear-resistant paper layer, the stone-plastic composite substrate layer, the polyvinyl chloride patterned fabric layer 2, and the melamine wear-resistant paper layer were laid in the mold of laminating equipment from bottom to top. Then the heat pressing was carried out at 150° C. and 5 MPa, in which the heat pressing time was 20 min.

After heat pressing, the composite was air cooled to room temperature and demoulded to obtain the laminate floor. The laminate floor obtained was cured at room temperature for 24 h, and then tempered. The tempering was conducted on the multi-layer hot pressing equipment, with tempering temperature of 90° C. and tempering time of 15 min. After tempering, the finished laminate floor was removed at a temperature of ≤80° C., and then was air cooled to room temperature.

### Example 5

The laminate floor and its manufacturing process in this example was based on Example 1, with the difference from Example 1 being in that: after heat pressing, the laminate was cooled naturally to room temperature and demoulded to obtain the laminate floor. The laminate floor obtained was cured at room temperature for 5 h, and then tempered.

### Example 6

The laminate floor and its manufacturing process in this example was based on Example 1, with the difference from Example 1 being in that: the surface of polyvinyl chloride patterned fabric layer was not precoated with a formulated glue.

### Comparative Example 1

The laminate floor and its manufacturing process differs from Example 1 in that:

tempering treatment was not carried out after heat pressing.

### Comparative Example 2

The laminate floor and its manufacturing process differs from Example 1 in that: the wear-resistant layer 1 was polyvinyl chloride layer.

Performance test

Laminate floors of the same thickness (12 mm) according to Examples 1-5 and the comparative examples were selected as samples, and subjected to the following tests:

1) the dimensional change rates were measured with reference to GB/T17657-2013. The test result is recorded and shown in Table 1:

TABLE 1
Test results of dimensional stability test (80° C., 6 h)

| | Example | Example | Example | Example | Example | Example | Comparative | Comparative |
|---|---|---|---|---|---|---|---|---|
| samples | 1 | 2 | 3 | 4 | 5 | 6 | example 1 | example 2 |
| Length | 0.17% | 0.17% | 0.15% | 0.16% | 0.23% | 0.18% | 0.50% | 0.26% |
| variation | | | | | | | | |
| width | 0.18% | 0.18% | 0.14% | 0.18% | 0.21% | 0.19% | 0.48% | 0.25% |
| variation | | | | | | | | |

From the experimental data in the above table, it can be seen that the size change in length direction and width direction of the laminate floor of the present application is controlled within 0.25%, showing excellent dimensional stability. At the same time, comparing the datum of Example 1, Example 5 and Comparative example 1, it can be seen that tempering can significantly improve the dimensional stability of the laminate floor, and the dimensional stability of the laminate floor obtained after tempering is improved as the cured time after demoulding increases.

The wear resistance of each sample was measured according to GB/T17657-2013. The test results were recorded in Table 2:

TABLE 2
Test results of wear-resistance

| | Example | Example | Example | Example | Example | Example | Comparative | Comparative |
|---|---|---|---|---|---|---|---|---|
| samples | 1 | 2 | 3 | 4 | 5 | 6 | example 1 | example 2 |
| Wear- | 9880 | 9800 | 9900 | 9950 | 9780 | 9740 | 9500 | 6850 |
| resistance/r | | | | | | | | |

It can be seen from the data in the above table, the wear resistance of each example of the present application was more than 9740 r, having excellent wear-resistance far better than that of the laminate floor with a conventional polyvinyl chloride wear layer (Comparative example 2)

The above are the preferred embodiments of the present application, which are not intended to limit the protection scope of the present application. Therefore, all equivalent changes made according to the structure, shape and principle of the present application should be covered within the protection scope of the present application.

What is claimed is:

1. A laminate floor comprising laminated wear-resistant layer, polyvinyl chloride patterned fabric layer, substrate layer, balance layer and mute layer, wherein the wear-resistant layer is a melamine wear-resistant paper layer.

2. The laminate floor according to claim 1, wherein at least one of a front face or a back face of the polyvinyl chloride patterned fabric layer is provided with an adhesive layer.

3. The laminate floor according to claim 2, wherein the adhesive layer comprises the following components by weight parts:
2-7 parts of chlorinated rubber;
8-12 parts of perchloroethylene resin;
2-7 parts of modified low-molecular polyamide hot-melt adhesive;
2-7 parts of tall oil;
0.5-1.5 parts of antioxidant; and
60-90 parts of organic solvent.

4. The laminate floor according to claim 1, wherein the substrate layer is selected from a group consisting of a stone-plastic composite substrate layer and a wood-plastic composite substrate layer.

5. The laminate floor according to claim 1, wherein the mute layer is selected from a group consisting of a cork layer, an ethylene-vinyl acetate copolymer foam, and an irradiation crosslinked polyethylene foam.

6. The laminate floor according to claim 1, wherein the polyvinyl chloride patterned fabric layer comprises a pattern layer printed by water-based polyvinyl chloride ink or oily polyvinyl chloride ink.

7. The laminate floor according to claim 1, wherein the balance layer is selected from a group consisting of a balance paper layer, a melamine wear-resistant paper layer, and a combination of a polyvinyl chloride film and a melamine balance paper layer.

8. A manufacturing process of the laminate floor according to claim 1, comprising the following steps:
material laying: laying the mute layer, the balance layer, the substrate layer, the polyvinyl chloride patterned fabric layer, and the wear-resistant layer from bottom to top in a mold of a laminating equipment;
heat pressing: performing heat pressing at 130-150° C. and 5-21 MPa for 20-60 min;
demoulding: air cooling to room temperature and demoulding to obtain the laminate floor; and
tempering: performing a second heat pressing at 80-100° C. to the laminate floor obtained by demoulding.

9. The manufacturing process of the laminate floor according to claim 8, wherein the tempering is carried out after completely cooling the laminate floor obtained by demoulding and curing for 24 hours.
